(19) United States
(12) Patent Application Publication
(10) Pub. No.: US 2013/0253760 A1
(43) Pub. Date: Sep. 26, 2013

(54) Vehicle Text-Cell Sensor

(71) Applicants: Michael J. Berman, Coral Springs, FL (US); Kenneth Alvin Hosfeld, Coral Springs, FL (US)

(72) Inventors: Michael J. Berman, Coral Springs, FL (US); Kenneth Alvin Hosfeld, Coral Springs, FL (US)

(21) Appl. No.: 13/708,907

(22) Filed: Dec. 7, 2012

Related U.S. Application Data
(60) Provisional application No. 61/568,238, filed on Dec. 8, 2011.

(51) Int. Cl. G07C 5/08

(52) U.S. Cl. CPC G07C 5/08
USPC 701/32.2

(57) ABSTRACT

A multi-port, multi access system that allows for any automotive impact to register exact time and quadrant of impact in a way that will allow it to be cross referenced to the driver's (of one or more vehicles) mobile cellular telephone usage at the time impact occurred, as an aid in determining and assigning accident responsibility.

This application claims priority from Provisional Patent 61/568,238 filed on Dec. 8, 2011.

### BACKGROUND OF THE INVENTION

### Problem Solved

This device would help to show if a driver involved in a vehicle accident was using a mobile cell phone prior to or during the moment of impact.

System that allows for any automotive impact to register exact time and quadrant of impact is disclosed. It is not believed that such a device currently exist.

### DETAILED DESCRIPTION OF THE INVENTION

As stated above, this device would help to show if a driver involved in a vehicle accident was using a mobile cell phone prior to or during the moment of impact. The invention claimed here solves this problem.

A multi-port, multi access system that allows for any automotive impact to register exact time and quadrant of impact in a way that will allow it to be cross referenced to the driver's (of one or more vehicles) mobile cellular telephone usage at the time impact occurred, as an aid in determining and assigning accident responsibility.

The claimed invention differs from what currently exists. It is not believed that such a device currently exists.

### Field of the Invention

This invention relates to safety systems for trailers, tractors and automobiles, as a system that will aid in determining responsibility for impact situations where one or more of the drivers are using a mobile cellular device at the moment of impact. By being able to establish responsibility, drivers will more likely drive responsibly, and be less likely to use cellular mobile devices in situations where their focus should be and can be on driving. The National Safety Council estimates at least 28% of all traffic accidents—or at least 1.6 million accidents each year—involve drivers using cell phones and texting. NSC estimates that 1.4 million accidents each year involve drivers using cell phones and a minimum of 200,000 additional accidents each year involve drivers who are texting.

“We now know that at least 1.6 million accidents involve drivers using cell phones and texting, ” said Janet Froetscher, president & CEO of the National Safety Council. “We know that cell phone use is a very risky distraction and texting is even higher risk. We now know that cell phone use is a factor in many more accidents than texting. The main reason is that millions more drivers use cell phones than text,” she said.

In constructing its estimates, NSC used widely-accepted statistical methods and analysis based on data of driver cell phone use from the National Highway Traffic Safety Administration (NHTSA) and from peer-reviewed research that quantifies the risk of using a cell phone and texting while driving. NSC's statistical model and estimates were peer-reviewed by academic researchers in traffic safety and biostatistics.

The estimate of 25% of all accidents—or 1.4 million accidents—involving cell phone use was derived from NHTSA data showing 11% of drivers at any one time are using cell phones and from peer-reviewed research reporting cell phone use increase accident risk by four times. The estimate of an additional minimum 3% of accident—or 200,000 accident—involving texting was derived by NHTSA data showing 1% of drivers at any one time are manipulating their device in ways that include texting and from research reporting texting increases accident risk by 8 times. Using the highest risk for texting reported by research of 23 times results in a maximum of 1 million accident attributable to texting; still less than the 1.4 million accident involving other cell phone use.

It is envisioned that the number of mobile cell phone related accidents could be reduced significantly if a device were installed on the vehicle that can A) record the exact moment of impact, B) relate the impact to specific section of the automobile, C) relate A) and B) to a precise time on a recording device that is both impact resistant and tamperproof and D) have an optional capability of recording mobile cell phone activity in the drivers vicinity at the moment of impact. Such a device would most likely first be used as a defense for the driver that does not use a cell phone during driving. In this case if the driver is involved in an accident, the driver could prove the time and point of impact. This together with the other driver's telephone records would show if the driver of the other vehicle was using the mobile cell phone during the moment of impact, thereby proving that the other driver was distracted, and most likely a cause of the accident.

As the popularity of use spreads, it could be adopted by insurance companies as part of a discount program to promote safe driving and lower claims cost often paid out even though the other driver (not insured by the company promoting the device caused the accident but it could not be proven).

### The Invention

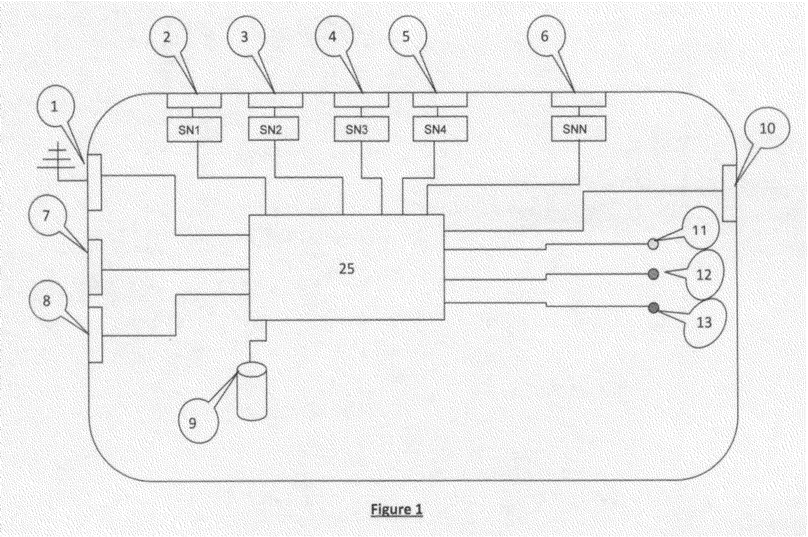

Ultimate acceptance would be to have such a device mandated as part of new car base equipment. At this point, drivers would be aware of potential liability associated with these non-safe driving habits and refrain from using the mobile cell phone during driving.
The invention is comprised of a secure impact resistant tamper proof box that houses the control processor unit (CPU) that connects to the various sensors (2-6 on FIG. 1) located throughout the vehicle as well as the optional wideband receiver (1 on FIG. 1).

The CPU will record and timestamp any sensor events that occur and store the information on a tamperproof memory device. If the optional wide band receiver is indicating activity at the time of a sensor event, that will also be indicated tamperproof memory device. The timestamp shall be encrypted and non changeable so as to avoid tampering. When an event occurs, a dedicated indicator light (11-13 on FIG. 1) will provide a visual indication. Sensors (2-5 on FIG. 1) can be adjusted to suit the needs of the vehicle so as not to falsely trigger an impact event. Sensors can be mounted in various positions on the vehicle depending on need. Sensors can be connected to the CPU via and means necessary (wired, wireless, or fiber optic). OBD-II vehicle data logger port (6 on FIG. 1) that would allow for data to be stored in an easily detachable module tailored meeting insurance company needs could be added. Indicator lights (11-13 on FIG. 1) can show a variety of indications such as On/Off Status, Correctly functioning, Malfunctioning and Impact has occurred. Other indications can be programmed as needed. Information can be extracted (8 on FIG. 1) from the device using any of several encrypted means using wired, wireless, or fiber optic connections. While the primary voltage to the device is provided by the automobiles battery (10 on FIG. 1), an internal battery (9 on FIG. 1) can provide power for memory and read outs for some period of time after failure or disconnect of the primary vehicle power source. A test port (7 on FIG. 1) is provided for authorized service. Tampering of either a physical or electrical nature will be easily noticeable, and in the case of electronic tampering attempts, a timestamp of the event will take place and the unit will go into alarm condition.

### The Version of The Invention Discussed Here Includes:

1: Optional wide band receiver monitoring near field microwave presence (will pick up cellular transmission around the driver)
2 thru 5: Motion accelerator/Impact sensor inputs 1 to N (N being the maximum number desired), can connect to sensors by wired/wireless/or fiber optic connections*
6: OBD-II vehicle data logger port that would allow for data to be stored in an easily detachable module tailored to meet insurance company needs.
7: Programming/Test port
8: secure data extraction port (can be wired/wireless/or fiber optic).
9: Backup battery (will allow the unit to retain information and running clock for up to two years with primary shut off)
10: input for external power (+12V from the vehicle battery).
11 thru 13: indication lights—On/Off Status,—Correctly functioning,—Malfunctioning,—Impact Has occurred,—Others to be programmed
25: CPU and secure tamperproof clock

### How the Invention Works

### Drawing Description

1. The Auto Sensor device (FIG. 1) is constructed inside a sealed tamperproof casing, with various connection options that allow for mounting in any vehicle. As an option, the circuit functionality (FIG. 1) could also be built into a vehicles onboard computer system, provided that a tamperproof memory and sensor interfaces are also incorporated.
2. The Auto Sensor device has an array of impact sensors (2, 3, 4, and 5 on FIG. 1) that can be Remote Acceleration Sensors, Remote Pressure Sensors, any combination thereof or a combined Remote Acceleration/Pressure sensors. The aforementioned Sensors may be internally mounted within the tamperproof casing or mounted on several sections of the vehicle and their connection to the Auto Sensor device (FIG. 1) may be wired or wireless. If wireless, the connection may use any of several wireless protocols available such as Bluetooth, Dect, WiFi, WiMax, Zigbee, Z-Wave, or other wireless protocol. The remote sensors (2,3,4, and 5 on FIG. 1) may be substituted with an incorporated programmable electronic gyroscopic device that will carry out the same functionality as the aforementioned Remote Acceleration and Pressure Sensors. Sensors will be set to register events that could result in damage to the vehicle.
3. The optional wideband receiver (1) is designed to detect mobile telephone devices or other devices utilizing the various mobile telephone operators' frequencies that are showing activity. The wideband receiver (1) is equipped with an antenna that, with the proper placement will be able to isolate just the drivers area of the vehicle to determine if activity is taking place in that area. This information will continuously be provided and an input to the CPU circuit (25).
4. The OBD-II data logger port (6) is able to output data in a “read only” format initially based on ISO 14230 KWP2000 (Keyword Protocol 2000). However, any of the other OBD-II formats may used, based on end customer needs.
5. The Programming/Test port (7) is used for proprietary access to the Auto Sensor and all of its components/functions so that the manufacturer or it representative can access the device for the purpose of securely reprogramming the device, resetting the device or to carry out detailed testing of the device. The port (7) will initially use a micro USB connector. However any number of connector types may eventually be used, such as but not limited to USB, Mini USB, DB-9, DB-25, Firewire, or other. A wireless secure access port is also envisioned. All communications between the device and the manufacturers test/programming equipment will be encrypted and password protected with limited attempts allowed before the device automatically prevents further attempts for a, yet to be determined, period of time. Any access to the device via this port (7) will cause the CPU circuit (25) to create a non-erasable record on the permanent event memory portion of the CPU circuit (25).
6. The Secure Data extraction port (8) is a read only port used to extract data stored on the secure memory portion of the CPU circuit (25). The port (8) will initially use a micro USB connector. However any number of connector types may eventually be used, such as but not limited to USB, Mini USB, DB-9, DB-25, Firewire, or other. A fiber optic access or wireless secure access port is also envisioned. Information may only be extracted by means of an authorized user password provided by the manufacturer. Limited password attempts allowed before the device automatically prevents further attempts for a, yet to be determined, period of time.
7. Indication Lights (11, 12, and 13) are multicolor Light Emitting Diodes (LEDs). By changing colors, combining colors or various blink codes, based on signals from the CPU circuit (25), a plurality of information can be obtained from the Indication Lights (11, 12, and 13). Additional LEDs could be added if required or needed).
8. Backup Battery (9) is a long life battery that will provide power to key portions of the CPU circuit (25) in case the primary voltage to the overall unit should fail. This is to ensure that primary logging is not lost even with a complete loss of power over an extended period of time.
9. The CPU or Control Processor Unit circuit (25) is a secure reprogrammable unit, which will manage inputs form all sensors. The CPU circuit (25) also contains the tamperproof high accuracy clock and the tamperproof readable/rewritable memory storage device. The Memory portion of the CPU circuit will be retained indefinitely, even if both primary and the backup battery were to fail.
10. When any event occurs on Sensors (2, 3, 4, or 5 individually or any combination of the Sensors), a signal will be sent to the CPU circuit (25). When an event signal is received by the CPU circuit or an analog signal that is monitored and the CPU circuit (25) triggers an event based on heuristic processing of the signal (threshold, rate of change, . . . ) (25), the CPU circuit (25) will immediately create and write to the memory storage device (part of 25) a record of the event. The record of this recorded event will be time stamped using the high accuracy tamperproof clock (part of 25). If an impact event were to occur, the memory can be read out and a comparison made with the mobile devices of all drivers (information on specific use at the time of the impact event would be retrieved from the mobile operator's whose customers were, or could have been involved). With this information and the time stamped, then possible distracted driving by one or more of the drivers involved can be established. If the wide band receiver (1) is in use, and if a recordable event occurs, then the event record will also include the information from the wideband receiver (1) in the record. Should any dispute arise as to the accuracy of the internal clock and the clocks used by other entities such as police, insurance company, and/or mobile operator, then a real time read out of the internal clock may obtained from the secure data extraction port (8) or OBD-II data logger port (6). With this comparative information, an accurate base time can be determined and further contribute to true results. Concurrent with an event being registered, the CPU circuit (25) will generate a signal that will enable one or more the Indication lights (11, 12 or 13) to light up and stay lit until a remote acknowledge signal is given. Any event once acknowledged will no longer be indicated on the indication lights (11, 12, or 13), but will remain stored on the CPU circuit (25) memory portion.
11. The CPU circuit (25) also has an upgradable and reprogrammable automatic test program. This program will continually check the functional parameters of the device and provide a visual indication of correct functionality via the indication lights (11, 12, or 13). As well, if the automatic test program detects a fault within the device, a malfunction indication will be provided via the indication lights (11, 12, or 13). Once a condition that has caused a malfunction has been resolved and the self test program has completed three correct functionality cycles, then the malfunction light will reset to off.

The invention is comprised of a secure impact resistant tamper proof box that houses the control processor unit (CPU) that connects to the various sensors (2-6 on FIG. 1) located throughout the vehicle as well as the optical wideband receiver (1 on FIG. 1). The CPU will record and timestamp any sensor events that occur and store the information on a tamperproof memory device. If the optional wide band receiver is indicating activity at the time of a sensor event, that will also be indicated tamperproof memory device. The timestamp shall be encrypted and non-changeable so as to avoid tampering. When an event occurs, a dedicated indicator light (11-13 on FIG. 1) will provide a visual indication. Sensors (2-5 on FIG. 1) can be adjusted to suit the needs of the vehicle so as not to falsely trigger an impact event. Sensors can be mounted in various positions on the vehicle depending on need. Sensors can be connected to the CPU via and means necessary (wired, wireless, or fiber optic). OBD-II vehicle data logger port (6 on FIG. 1) that would allow for data to be stored in an easily detachable module tailored meeting insurance company needs could be added. Indicator lights (11-13 on FIG. 1) can show a variety of indications such as On/Off Status, Correctly functioning, Malfunctioning and Impact has occurred. Other indications can be programmed as needed. Information can be extracted (8 on FIG. 1) from the device using any of several encrypted means using wired, wireless, or fiber optic connections. While the primary voltage to the device is provided by the automobiles battery (10 on FIG. 1), an internal battery (9 on FIG. 1) can provide power for memory and read outs for some period of time after failure or disconnect of the primary vehicle power source. A test port (7 on FIG. 1) is provided for authorized service. Tampering of either a physical or electrical nature will be easily noticeable, and in the case of electronic tampering attempts, a timestamp of the event will take place and the unit will go into alarm condition.

### How to Make the Invention

The invention is comprised of a secure impact resistant tamper proof box that houses the control processor unit (CPU) that connects to the various sensors (2-6 on FIG. 1) located throughout the vehicle as well as the optional wideband receiver (1 on FIG. 1). The CPU will record and timestamp any sensor events that occur and store the information on a tamper proof memory device. If the optional wide band receiver is indicating activity at the time of a sensor event, that will also be indicated tamperproof memory device. The timestamp shall be encrypted and non-changeable so as to avoid tampering. When an event occurs, a dedicated indicator light (11-13 on FIG. 1) will provide a visual indication. Sensors (2-5 on FIG. 1) can be adjusted to suit the needs of the vehicle so as not to falsely trigger an impact event. Sensors can be mounted in various positions on the vehicle depending on need. Sensors can be connected to the CPU via and means necessary (wired, wireless, or fiber optic). OBD-II vehicle data logger port (6 on FIG. 1) that would allow for data to be stored in an easily detachable module tailored meeting insurance company needs could be added. Indicator lights (11-13 on FIG. 1) can show a variety of indications such as On/Off Status, Correctly functioning, Malfunctioning and Impact has occurred. Other indications can be programmed as needed. Information can be extracted (8 on FIG. 1) from the device using any of several encrypted means using wired, wireless, or fiber optic connections. While the primary voltage to the device is provided by the automobiles battery (10 on FIG. 1), an internal battery (9 on FIG. 1) can provide power for memory and read outs for some period of time after failure or disconnect of the primary vehicle power source. A test port (7 on FIG. 1) is provided for authorized service.

1: Optional wide band receiver monitoring near field microwave presence (will pick up cellular transmission around the driver)

2 thru 5: Necessary Motion accelerate/Impact sensor inputs 1 to N (N being the maximum number desired), can connect to sensors by wired/wireless/or fiber optic connections*

6: Optional OBD-II vehicle data logger port that would allow for data to be stored in an easily detachable module tailored to meet insurance company needs.

7: Necessary Programming/Test port

8: Necessary secure data extraction port (can be wired/wireless/or fiber optic).

9: Necessary Backup battery (will allow the unit to retain information and running clock for up to two years with primary power shut off)

10. Necessary input for external power (+12V from the vehicles battery).

11 thru 13: Necessary indication lights
On/Off Status
Correctly functioning
Malfunctioning
Impact has occurred.
Others to be programmed.

25: Necessary CPU and secure tamperproof clock.

Other type of connectors could be substituted and or changed, yet allow the unit to function in the same way.

Additional types of sensors could be added at a future data that will enhance the operation and or extend the performance characteristics.

### How to Use the Invention

With the sensors placed around the vehicle, any impact will be recorded using an internal tamperproof clock as a time stamp. In addition, other conditions present at the moment of impact, such as if or not the driver was using his cell phone at the same time the impact occurred, or other parameters as are desired, will also be recorded and time stamped. This together with telephone records of both drivers can be compared and a clear picture of the mobile cellular activities at the moment of impact can be established. This, in turn will help establish fault for purpose of police traffic citations and whose insurance company will pay for the damage. This can be very important in cases where an injury has occurred.

Additionally: This technology could also be used in water craft.

1. A device that logs the date and time of any collision or impact consisting of:
a cpu with tamperproof clock;
a battery backup;
nonvolatile and tamper resistant memory that securely stores an event log consisting, at a minimum, of the exact date and time of any impacts or collisions that are detected by the attached sensors;
an input for external power from the vehicles power system;
a secure data extraction port that allows the secure transfer of the event log;
a programming and/or test port;
a status light indicating the device is on;
a status light indicating the device is correctly functioning;
a status light indicating an impact event has occurred;
one or more acceleration/inertia and/or impact sensors, said sensors may be any combination of built-in and/or externally mounted and connected utilizing wired, wireless or fiber optic mechanisms.

2. Device of claim one further comprising an OBD-II data logger port used to obtain vehicle status information such as speed, throttle position, status of breaks, etc.

3. Device of claim one further comprising a wide band receiver capable of detecting the presence of near field radio in the proximity of the driver.

4. Device of claim one further comprising additional status indicator light or lights as necessary.

5. Device of claim one that upon detection attempts to tamper or intrude cause an event log include date and time of event.

6. Device of claim two further comprising a wide band receiver capable of detecting the presence of near field radio in the proximity of the driver.

7. Device of claim two further comprising additional status indicator light or lights as necessary.

8. Device of claim two that upon detection attempts to tamper or intrude cause an event log include date and time of event.

9. Device of claim three further comprising additional status indicator light or lights as necessary.

10. Device of claim three that upon detection attempts to tamper or intrude cause an event log include date and time of event.

11. Device of claim four that upon detection attempts to tamper or intrude cause an event log include date and time of event.

12. Device of claim 6 further comprising additional status indicator light or lights as necessary.

13. Device of claim 6 that upon detection attempts to tamper or intrude cause an event log include date and time of event.

14. Device of claim 9 that upon detection attempts to tamper or intrude cause an event log include date and time of event.

15. Device of 12 that upon detection attempts to tamper or intrude cause an event log include date and time of event.

16. A system that logs the date and time of any collision or impact consisting of:
a software program;
nonvolatile and tamper resistant memory that securely stores an event log consisting, at a minimum, of the exact date and time of any impacts or collisions that are detected by available sensors;
said system having a means to securely transfer or extract the event log;

17. A system of claim 16 that can operate in a smartphone.

18. A system of claim 17 that automatically starts when the smartphone is powered on.

19. A system of claim 18 that automatically restarts whenever the software exits.

20. A system of claim 17 that logs date and time of phone use in the event queue.

21. A system of claim 17 that logs date and time of send and received text messages in the event queue.

22. A system of claim 18 that logs date and time of phone use in the event queue.

23. A system of claim 18 that logs date and time of send and received text messages in the event queue.

24. A system of claim 19 that logs date and time of phone use in the event queue.

25. A system of claim 19 that logs date and time of send and received text messages in the event queue.
